(19) United States
(12) Patent Application Publication
(10) Pub. No.: US 2025/0055337 A1
(43) Pub. Date: Feb. 13, 2025

(54) COVER PLATE OF A ROTOR, ROTOR, AND METHOD FOR MOUNTING A ROTOR

(71) Applicant: GKN Automotive Limited, Birmingham (GB)

(72) Inventors: Daniel Martino, Bruneck (IT); Sigmund Senoner, Bruneck (IT)

(21) Appl. No.: 18/786,651

(22) Filed: Jul. 29, 2024

(30) Foreign Application Priority Data
Aug. 8, 2023 (DE) 102023121149.8

(51) Int. Cl. H02K 1/32; H02K 1/276; H02K 1/28

(52) U.S. Cl. CPC H02K 1/32; H02K 1/276; H02K 1/28

(57) ABSTRACT

Cover plate of a rotor of an electric machine, wherein the cover plate has a contact surface which is intended to lie against a laminated core of the rotor; rotor of an electric machine, wherein the rotor is rotatable about an axis of rotation and has a laminated core, wherein at least one cover plate is arranged at an axial end of the laminated core; and method for mounting a rotor, wherein the cover plate and the laminated core are arranged on a rotor shaft, wherein permanent magnets are arranged in first recesses of the laminated core and wherein the recesses are filled with a plastic in order to embed the permanent magnets in the first recesses.

### CROSS-REFERENCE TO RELATED APPLICATION

This application claims priority to German Patent Application No. DE 102023121149.8, filed on Aug. 8, 2023, which application is hereby incorporated herein by reference in its entirety.

### TECHNICAL FIELD

The application relates to a cover plate for a rotor in the field of electric machines. The cover plate has a contact surface bearing against a laminated core of the rotor. The application further relates to a rotor of an electric machine and to a method for mounting a rotor.

### BACKGROUND

Electrical machines are known in the art. Such electric machines comprise a stator and at least one rotor, which is rotatable about an axis of rotation relative to the stator.

DE 10 2020 128 552 A1 relates to a rotor for a permanent magnet synchronous machine, with a laminated core with recesses in which respective permanent magnets are accommodated. The recess has a first end section that is closer to an axis of rotation of the rotor than a second end section. In recesses which are adjacent to each other and whose first end sections are closer to each other in the circumferential direction of the rotor than the second end sections, the permanent magnets are arranged in such a way that magnetic north poles N of the permanent magnets face each other. The rotor arranged in such a permanently excited synchronous machine has clamping disks or cover disks between which the laminated cores are pressed against each other. Boreholes can be made in a number of positions in these clamping disks. By providing corresponding boreholes at one or more of these positions, the rotor can be balanced or imbalances in the rotation of the rotor can be eliminated.

DE 199 15 664 A1 discloses an electrical machine with a stator and a rotor with at least one laminated core, which has the following features: at least two different lamination cuts of the laminations of the laminated core, at least the laminations of one lamination cuts are provided with means which, in particular when the individual laminations are axially assembled, effect a radial fixing of these laminations within the laminated core. The laminated core of the rotor has recesses for permanent magnets, wherein the permanent magnets can be fixed by inserting a hardenable compound.

### SUMMARY

According to an aspect, a cover plate for a rotor of an electric machine has a contact surface, which is intended to lie against a laminated core of the rotor, at least one venting duct being formed in the form of a groove in the contact surface.

When assembling the rotor for a permanent magnet synchronous machine with integrated permanent magnets (IPMSM), permanent magnets are inserted into cavities provided for this purpose in the laminated core. The laminated core, with the permanent magnets inserted, are together arranged on a rotor shaft, which has a shoulder against which the laminated core is braced. The rotor shaft has an axis of rotation. The references to axial, radial and circumferential directions generally refer to this axis of rotation. A cover plate is arranged at both axial ends of the laminated core, which is used, for example, to compensate for an imbalance at the end of the rotor assembly by drilling boreholes into the cover plates. These are therefore also known as balancing washers or compensation disks. For rotor shafts having a shoulder, it is not possible to retrofit one of the cover plates. This can only be done before mounting the laminated core on the rotor shaft. To embed the magnets, they are overmolded with a curable plastic. Air must escape from the cavities, which is hindered by the cover plate already in place. Therefore, the cover plate has a venting duct through which the air can advantageously escape. The venting duct in the form of a groove in the contact surface, which lies against the laminated core, allows the air to be discharged from the cavities occupied by the permanent magnets into other cavities of the laminated core that remain unoccupied.

According to an embodiment, it is provided that the venting duct is shaped and/or dimensioned such that air can escape through the venting duct, wherein a curable plastic hardens in the venting duct before the curable plastic can escape from the venting duct. For this purpose, the venting duct can have a maximum extension of less than 0.2 mm in a direction perpendicular to a plane formed by the contact surface, or by less than 0.1 mm, or have a maximum extension between 0.03 mm and 0.05 mm. The direction perpendicular to the plane formed by the contact surface corresponds to an axial direction. This means that the venting duct does not extend further than its maximum axial extension into the cover plate. To ensure that the curable plastic hardens, it may be sufficient for the venting duct to have the specified maximum extension in sections.

According to an embodiment, the venting duct may have a plurality of duct sections, which do not necessarily have to be connected. The venting duct can extend continuously or with interruptions around the circumference of the cover plate.

According to a further embodiment, it is provided that the venting duct has a cross-sectional area of less than 0.5 mm², or of less than 0.2 mm², or between 0.10 mm² and 0.15 mm². Furthermore, a first dimension of the venting duct determining the cross-sectional area can be significantly larger than a second dimension of the venting duct determining the cross-sectional area, i.e. at least by a factor of 20 larger, or at least by a factor of 50 larger, or by about a factor of 60 larger. The size and shape of the venting duct allows the venting of air. The curable plastic hardens rapidly in the venting duct dimensioned in this way, closes it and thus advantageously does not get into the unoccupied cavities of the laminated core. The first dimension of the venting duct that determines the cross-sectional area can be its width transverse to the axis of rotation. The second dimension of the venting duct that determines the cross-sectional area can be its extension in the direction perpendicular to the plane formed by the contact surface, which can also be referred to as the axial extension. In the case of a rectangular cross-section, the first dimension determining the cross-sectional area is the longer side of the rectangle and the second dimension determining the cross-sectional area is the shorter side of the rectangle. The longer side can be 3 mm long, for example, while the shorter side is 0.05 mm long, for example. The cross-sectional area can have other shapes, for example semi-oval or semi-elliptical. The first dimension of an ellipse that determines the cross-sectional area is the largest distance between the center and the ellipse, while the second dimension that determines the cross-sectional area is the smallest distance between the center and the ellipse.

Depending on the position of the cavities in the laminated core, the shape of the venting duct can be adapted to enable the described venting. For example, the venting duct can have at least one outer duct section, one inner duct section and one radial duct section, respectively, wherein the outer duct section is arranged further outwards in the radial direction than the inner duct section and wherein the outer duct section is connected to the inner duct section via the radial duct section. In particular, this allows end sections of the cavities for the permanent magnets with different radial distances to the axis of rotation to be connected to the venting duct. As the magnets per pole are often arranged in pairs and in a V-shape to each other, the end sections of the cavities for the permanent magnets have different radial distances to the axis of rotation.

The inner duct section and/or the outer duct section can be made continuous in the circumferential direction. Furthermore, a plurality of outer duct sections may be provided, each of the outer duct sections being connected to the continuous inner duct section via a radial duct section.

According to a further embodiment, a positioning means is provided which determines a defined position of the cover plate in the circumferential direction relative to the rotor.

According to a further embodiment, it is provided that the cover plate is a cast part.

A further aspect relates to a rotor of an electric machine, wherein the rotor is rotatable about an axis of rotation and has a laminated core, wherein at least one of the cover plates is designed as described above and is arranged at an axial end of the laminated core.

According to an embodiment, it is provided that the laminated core has first recesses and second recesses, with the first recesses being provided for accommodating permanent magnets.

According to a further embodiment, it is provided that at least end sections of the first recesses and the second recesses are fluidically connected to the venting duct.

According to a further embodiment, it is provided that the first recesses for embedding the permanent magnets are filled with a curable plastic, with the plastic extending into partial areas of the venting duct.

According to a further embodiment, it is provided that the laminated core is fixedly connected to a rotor shaft, the rotor shaft having counter-positioning means which, together with the positioning means, determine the relative position of the cover plate and the rotor shaft in the circumferential direction.

According to a further embodiment, it is provided that the rotor shaft has a shoulder against which the laminated core is braced, with the cover plate being arranged between the shoulder and the laminated core.

A further aspect relates to a method for assembling the rotor described above, wherein the cover plate and the laminated core are arranged on the rotor shaft, wherein permanent magnets are arranged in first recesses of the laminated core, wherein the first recesses are filled with a curable plastic in order to embed the permanent magnets in the first recesses, wherein the first recesses are vented during filling with plastic by discharging the air into second recesses via the venting ducts.

A risk of the plastic getting between the laminations of the laminated core or even escaping to the outside of the laminated core is advantageously reduced. A quality check can be carried out visually from the unsealed side of the laminated core via the second recesses. This allows to recognize whether the plastic has penetrated the second recesses. From a cost point of view, the cover plate can be cast without the need for elaborate post-processing. The tool for filling the first recesses can be advantageously simplified, as the functionality of the venting during filling is already realized by the cover plate.

### BRIEF DESCRIPTION OF THE DRAWINGS

The cover plate, the rotor and the method are further illustrated below with reference to an exemplary embodiment shown in the accompanying drawings, wherein

FIG. 1 shows an embodiment of a rotor of an electric machine with at least one cover plate;

FIG. 2 shows a perspective view of the rotor as shown in FIG. 1, partially assembled;

FIG. 3 shows a perspective view of the cover plate according to FIG. 1;

FIG. 4 shows a sectional view of the rotor as shown in FIG. 2.

### DETAILED DESCRIPTION

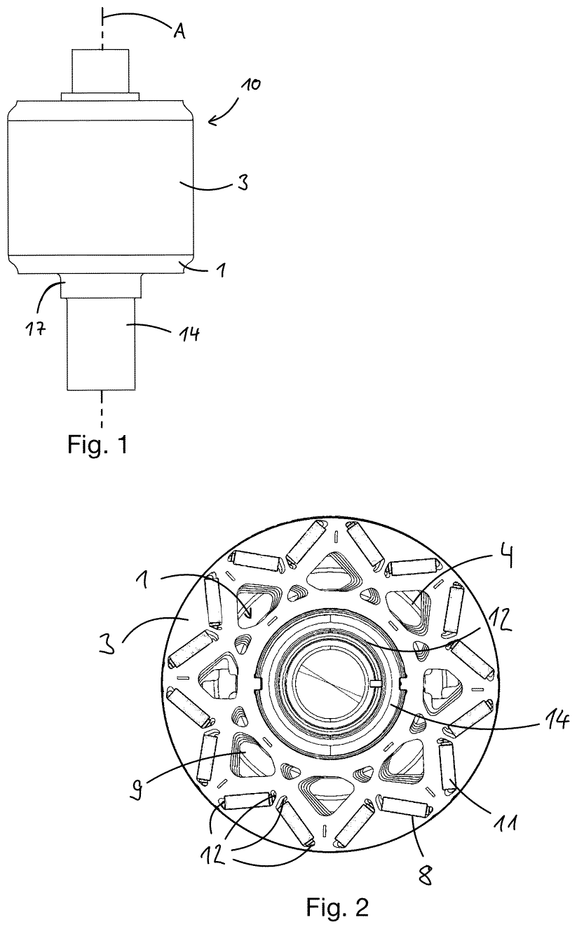

In FIG. 1, a rotor 10 of an electric machine with two cover plates 1 is illustrated. The rotor 10 is rotatable about an axis of rotation A and has a laminated core 3. The cover plates 1 are each arranged at axial ends of the laminated core 3. The laminated core 3 is fixedly connected to a rotor shaft 14, which has a shoulder 17 against which the laminated core 3 is braced, one of the cover plates 1 being arranged between the shoulder 17 and the laminated core 3. The following statements show that only one of the cover plates 1 needs to have the configuration with the cover plate 1 arranged between the shoulder 17 and the laminated core 3. Specifications such as axial, radial and circumferential direction generally refer to the axis of rotation A as shown in FIG. 1.

FIG. 2 shows the rotor according to FIG. 1 partially assembled. One of the cover plates 1 is removed and the slightly perspective view reveals individual rotor laminations that are joined together to form the laminated core 3 and are positively connected to the rotor shaft 14 in the circumferential direction. The laminated core 3 has first recesses 8 and second recesses 9, with the first recesses 8 being provided to accommodate permanent magnets 11. The second recesses 9 remain unoccupied and serve, for example, for a ventilation of the rotor 1 during operation and to reduce weight.

When assembling the rotor 1, the permanent magnets 11 are inserted into the cavities provided for this purpose in the first recesses 8 in the laminated core 3. The laminated core 3 is arranged on the rotor shaft 14 together with the inserted permanent magnets 11. As the rotor shaft 14 has a shoulder 17, it is not possible to insert the cover plate 1 at a later stage. This can only be done before mounting the laminated core 3 on the rotor shaft 14. In order to fasten the magnets 11 in this assembly in the first recesses 8, the first recesses 8 are filled with a curable plastic (not shown), for example by overmolding with a thermoset. The magnets and the adjacent areas of the laminated core have a temperature of around 180° C. to allow the thermoset to be injected. To avoid deformation of the laminated core 3 and other unfavorable reactions to an inhomogeneous temperature distribution, the entire assembly is brought to a constant temperature. Boundary conditions for this process are, besides the temperature, to ensure the thightness of the cavities to be filled. A pressure of around 60 bar is built up and the laminated core 3 is pressed together with a force of around 200 kN.

The thermoset is injected into the first recesses 8 from one side. Air that is in the cavities leaves the first recesses 8 on the opposite side. The cover plate already positioned there can prevent air from escaping, which can lead to unwanted air pockets. Therefore, the cover plate 1 has a venting duct 4 that fluidically connects at least end sections 12 of the first recesses 8 with the second recesses 9, so that the first recesses 8 can be vented during filling by discharging the air into the second recesses 9 via the venting duct 4.

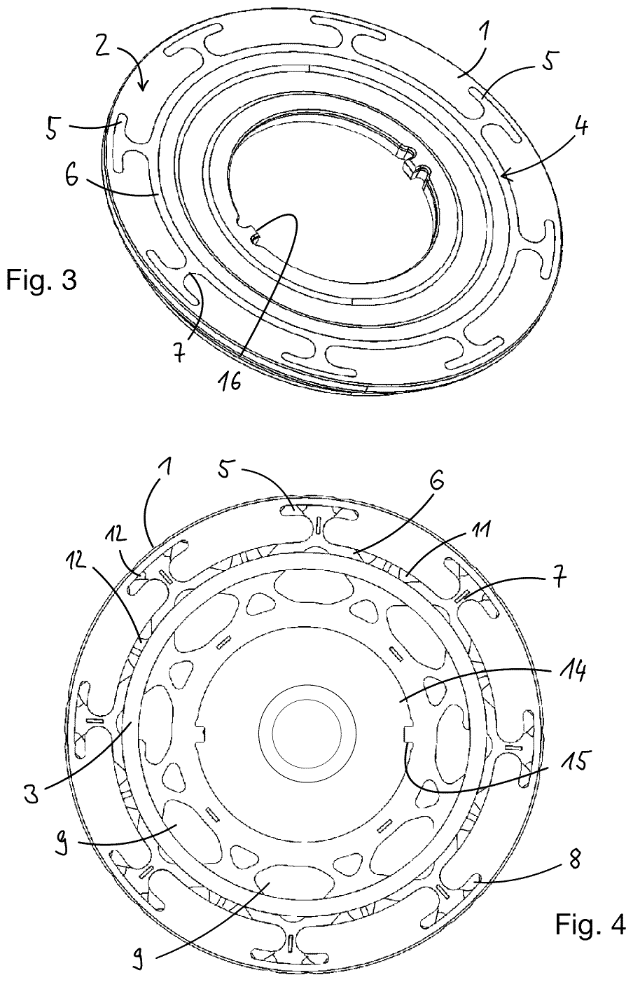

In FIG. 3, the cover plate 1 is illustrated in perspective. The cover plate 1 has a contact surface 2 which, when mounted, rests against the laminated core 3 of the rotor 1 as shown in FIG. 1. The venting duct 4 is formed in the form of a groove in the contact surface 2. In particular, the cover plate 1 can be a cast part, for example made of aluminum or plastic. A positioning means 16 is provided, which determines a defined position of the cover plate 1 in the circumferential direction relative to the rotor 10. The venting duct 4 is advantageously shaped and/or dimensioned such that air can escape through the venting duct 4, whereby a curable plastic cures in the venting duct 4 before the curable plastic leaves the venting duct 4. For this purpose, the venting duct can have a maximum extension of between 0.03 mm and 0.05 mm in a direction perpendicular to a plane formed by the contact surface 2.

The arrangement of the venting duct 4 is such that the first recesses 8 are fluidically connected to the second recesses 9, as described above. For this purpose, the venting duct 4 in the illustrated embodiment example has a shape adapted to the position of the first recesses 8 and the second recesses 9. The venting duct 4 does not have to be continuous. A plurality of channel sections can each connect neighboring first recesses 8 and second recesses 9. The venting duct 4 extends continuously or in duct sections around a circumference of the cover plate 1.

In the illustrated exemplary embodiment, the venting duct 4 has several outer duct sections 5 and a continuous inner duct section 6, the outer duct sections 5 being arranged further outwards in the radial direction in relation to the axis of rotation A in FIG. 1 than the inner duct section 6. The inner duct section 6 and the outer duct sections 5 are arranged on concentric circles. One radial duct section 7 each connects one of the outer duct sections 5 to the inner duct section 6.

In FIG. 4, the rotor according to FIG. 2 is shown in a sectional view, with the section arranged perpendicular to the axis of rotation A through the cover plate 1, so that the venting duct 4 is visible. The rotor shaft 14 has counter-positioning means 15 which, together with the positioning means 16, determine the relative position of the cover plate 1 and the rotor shaft 14 in the circumferential direction. In the illustrated exemplary embodiment, the counter-positioning means 15 form a feather key connection with the positioning means 16.

The laminated core 3 is visible behind the cover plate 1. The view shows that the first recesses 8 are fluidically connected to the second recesses 9 due to the shape of the venting duct 4. In particular, the end sections 12 of the first recesses 8, which are filled with plastic, are at least partially in axial overlap with the outer duct sections 5 and with the continuous inner duct section 6. The inner duct section 6 also partially overlaps axially with the second recesses 9, so that air escaping from the first recesses 8 reaches the second recesses 9 via the venting duct 4.

The venting duct 4 can have a cross-sectional area of less than 0.5 mm², of less than 0.2 mm² and further between 0.10 mm² and 0.15 mm². This advantageously prevents the plastic from entering the second recesses 9 during injection, as it hardens beforehand. Once the injection is complete, the plastic therefore extends into parts of the venting duct 4.

In particular, a first dimension of the venting duct is significantly larger than a second dimension of the venting duct, which is therefore either particularly flat or particularly narrow. In the depicted exemplary embodiment, the maximum extension of the venting duct 4 in the axial direction is significantly smaller than its width in the radial or circumferential direction. Such a flat venting duct 4 is easy to realize in a cast part. The width of the venting duct 4 may be at least by a factor of 20 greater than its height, or by at least a factor of 50 greater, or by a factor of about 60.

### LIST OF REFERENCE NUMERALS

1 Cover plate
2 Contact surface
3 Laminated core
4 Venting duct
5 Outer duct section
6 Inner duct section
7 Radial duct section
8 First recess
9 Second recess
10 Rotor
11 Permanent magnet
12 End section
14 Rotor shaft
15 Counter-positioning means
16 Positioning means
17 Shoulder
A Axis of rotation

The invention claimed is:

1. A cover plate for a rotor of an electrical machine, the cover plate comprising
a contact surface for bearing against a laminated core of the rotor and at least one venting duct,
wherein the at least one venting duct is formed in the contact surface in the form of a groove.

2. The cover plate according to claim 1, wherein the venting duct has a maximum extension of less than 0.2 mm in a direction perpendicular to a plane formed by the contact surface.

3. The cover plate according to claim 1, wherein the venting duct has a cross-sectional area of less than 0.5 mm².

4. The cover plate according to claim 3, wherein a first dimension of the venting duct determining the cross-sectional area is larger than a second dimension of the venting duct determining the cross-sectional area at least by a factor of 20.

5. The cover plate according to claim 1, wherein the venting duct comprises at least one outer duct section, at least one inner duct section and at least one radial duct section, wherein the at least one outer duct section is arranged further outwards in the radial direction than the at least one inner duct section and wherein the at least one outer duct section is connected to the at least one inner duct section via the at least one radial duct section.

6. The cover plate according to claim 1, wherein a plurality of the outer duct sections and one continuously formed inner duct section are provided, each one of the outer duct section being connected to the continuously formed inner duct section via one of the radial duct sections.

7. The cover plate according to claim 1, further comprising a positioning means provided to fix a defined position of the cover plate in the circumferential direction relative to the rotor.

8. The cover plate according to claim 1, wherein the cover plate is a cast part.

9. A rotor of an electric machine, comprising at least one cover plate according to claim 1 and a laminated core, wherein the rotor is rotatable about an axis of rotation (A) and wherein the cover plate is arranged at an axial end of the laminated core.

10. The rotor according to claim 9, further comprising permanent magnets, wherein the laminated core has first recesses and second recesses, the first recesses being provided for accommodating the permanent magnets, at least end sections of the first recesses and the second recesses being fluidically connected to the venting duct.

11. The rotor according to claim 10, wherein a plastic embeds the permanent magnets in the first recesses, the plastic extending into partial regions of the venting duct.

12. The rotor according to claim 9, further comprising a rotor shaft, wherein the laminated core is fixedly connected to the rotor shaft, wherein the rotor shaft has counter-positioning means which, together with the positioning means, determine the relative position of the cover plate and the rotor shaft in the circumferential direction.

13. The rotor according to claim 12, wherein the rotor shaft has a shoulder against which the laminated core is braced, the cover plate being arranged between the shoulder and the laminated core.

14. A method for mounting the rotor according to claim 9, wherein the cover plate and the laminated core are arranged on a rotor shaft, the permanent magnets are arranged in first recesses of the laminated core, wherein the first recesses are filled with a plastic material in order to embed the permanent magnets in the first recesses, wherein the first recesses are vented during filling with the plastic material by discharging the air into second recesses via the venting duct.

15. A cover plate for a rotor of an electrical machine, the cover plate comprising
a contact surface for bearing against a laminated core of the rotor and at least one venting duct,
wherein the at least one venting duct is formed in the contact surface in the form of a groove having a cross-sectional area of less than 0.5 mm², and
wherein a first dimension of the venting duct determining the cross-sectional area is larger than a second dimension of the venting duct determining the cross-sectional area at least by a factor of 20.
